(19) United States
(12) Patent Application Publication
(10) Pub. No.: US 2025/0083751 A1
(43) Pub. Date: Mar. 13, 2025

(54) Flat Tire Prevention Device

(71) Applicants: Curtis Pollard, JR., Camden, SC (US); Tomacha Pollard, Camden, SC (US)

(72) Inventors: Curtis Pollard, JR., Camden, SC (US); Tomacha Pollard, Camden, SC (US)

(21) Appl. No.: 18/829,601

(22) Filed: Sep. 10, 2024

Related U.S. Application Data
(60) Provisional application No. 63/581,778, filed on Sep. 11, 2023.

(51) Int. Cl. B62D 25/18; H01F 7/02

(52) U.S. Cl. CPC B62D 25/18; H01F 7/02

(57) ABSTRACT

A flat tire prevention device is disclosed that helps prevent flat or punctured tires while driving. The flat tire prevention device comprises a magnetic component that is configured in a square or rectangular shape depending on the size and shape of the vehicle's mudflaps. The magnetic component is typically a thin, magnetic plate that would magnetically adhere to a vehicle's mudflaps, during use. The exposed surface of the magnetic component would also be magnetic, to attract debris before it is run over by the vehicle's tires. Thus, the magnetic component extends over the roadway area to pick up any metallic debris before it punctures the vehicle's tires.

### CROSS-REFERENCE TO RELATED APPLICATION

The present application claims priority to, and the benefit of, U.S. Provisional Application No. 63/581,778, which was filed on Sep. 11, 2023, and is incorporated herein by reference in its entirety.

### FIELD OF THE INVENTION

The present invention relates generally to the field of flat tire prevention devices. More specifically, the present invention relates to a flat tire prevention device for cars, trucks, vans, SUVs, and any other vehicles. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in flat tire prevention devices. Generally, suffering from a flat tire while on the way to work, the store, or any other destination can be incredibly frustrating and inconvenient. Further, people may end up with a flat tire in remote destinations and be unable to repair it on their own, ultimately being stranded until help arrives. Additionally, unexpected repair bills can be expensive.

Furthermore, it is well known that vehicles of various types employ mud flaps behind and adjacent to the wheels of the vehicle, the mud flaps serving to reduce or eliminate the amount of spray from wet or snowy road cover and also the amount of rocks and other road debris that would otherwise be thrown backward by the vehicle wheels. What is needed, therefore, is a device that utilizes mudflaps to prevent flat tires.

Accordingly, there is a demand for an improved flat tire prevention device that comprises a magnetic mudflap for collecting nails, screws, and other magnetic debris from a road. More particularly, there is a demand for a flat tire prevention device that reduces the chance of getting a flat tire.

Therefore, there exists a long-felt need in the art for a flat tire prevention device that provides users with a means for preventing flat tires for cars, trucks, vans, SUVs, and any other vehicles. There is also a long-felt need in the art for a flat tire prevention device that features a magnetic interior that secures the device on the mudflap near the vehicle's front tires. Further, there is a long-felt need in the art for a flat tire prevention device that allows nails, screws, and other magnetic debris to be collected by the magnetic front plate on the device. Moreover, there is a long-felt need in the art for a device that reduces the chance of getting a flat tire, preventing unexpected expenses, or getting stranded in dangerous areas. Further, there is a long-felt need in the art for a flat tire prevention device that allows users to secure the device to a vehicle and its mudflap via a magnetic connection. Finally, there is a long-felt need in the art for a flat tire prevention device that comprises a magnetic interior to attract debris before it is run over by the tires.

The subject matter disclosed and claimed herein, in one embodiment thereof, comprises a flat tire prevention device. The device is a nail, screw, and metal debris catching device that helps prevent flat or punctured tires while driving. The flat tire prevention device comprises a magnetic component that is configured in a square or rectangular shape depending on the size and shape of the vehicle's mudflaps. The magnetic component is typically a thin, magnetic plate that would magnetically adhere to a vehicle's mudflaps, during use. The exposed surface of the magnetic component would also be magnetic, to attract debris before it is run over by the vehicle's tires. Thus, the magnetic component extends over the roadway area to pick up any metallic debris before it punctures the vehicle's tires. In another embodiment, the magnetic component is secured to a mudflap and then installed on a vehicle without mudflaps.

In this manner, the flat tire prevention device of the present invention accomplishes all of the foregoing objectives and provides users with a device that provides protection against flat tires. The device is a magnetic plate that is adhered to a vehicle mudflap. The device comprises a magnetic material to attract debris before it is run over by the tires.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flat tire prevention device. The device is a nail, screw, and metal debris catching device that helps prevent flat or punctured tires while driving. The flat tire prevention device comprises a magnetic component that is configured in a square or rectangular shape depending on the size and shape of the vehicle's mudflaps. The magnetic component is typically a thin, magnetic plate that would magnetically adhere to a vehicle's mudflaps, during use. The exposed surface of the magnetic component would also be magnetic, to attract debris before it is run over by the vehicle's tires. Thus, the magnetic component extends over the roadway area to pick up any metallic debris before it punctures the vehicle's tires.

In one embodiment, the flat tire prevention device reduces the chance of getting a flat tire, preventing unexpected expenses, or getting stranded in dangerous areas due to a flat and/or punctured tire. The flat tire prevention device can be secured to any suitable vehicle, such as cars, trucks, vans, SUVs, RVs, etc., or any other suitable vehicle as is known in the art. Generally, the flat tire prevention device can be secured to any existing vehicle mudflap as is known in the art or can be secured to a stand-alone mudflap which is then secured to a vehicle.

In one embodiment, the flat tire prevention device comprises a magnetic component that is configured in a square or rectangular shape depending on the size and shape of the vehicle's mudflaps but can be configured in any suitable shape as is known in the art. Further, the magnetic component is typically a thin, magnetic plate that partially covers the vehicle's mudflaps. Accordingly, the magnetic component can be any suitable size and shape as is known in the art, as long as the magnetic component acts to cover a majority of a vehicle's mudflaps. Typically, the magnetic component comprises a front surface (facing away from the vehicle), a rear surface (facing the mudflap or tire), opposing side walls, and opposing top and bottom edges. The width of the magnetic component can be approximately between ⅛-½″ thick, the thicker the width, the more heavy-duty the magnetic component.

In one embodiment, the magnetic component is manufactured of a permanent magnet. Permanent magnets do not lose their magnetic property once they are magnetized. Typical examples of permanent magnets include ceramic or ferrite, alnico (made from combining mostly aluminum, nickel, iron, and cobalt), samarium cobalt (SmCo), or neodymium iron boron (NIB). Samarium cobalt and neodymium iron boron are rare earth magnets. The magnetic component can be manufactured with any of these magnets, or any other suitable magnet as is known in the art.

In one embodiment, while the magnetic component is shown as being mounted to a vehicle's mudflaps aftermarket, such that the magnetic component and the mudflap are separate components, it would be obvious to one of skill in the art that the magnetic component and the mudflap can be a unitary construction, formed together beforehand and then secured to a vehicle as a single component.

In one embodiment, the magnetic component is secured to a vehicle's mudflaps via a magnetic attachment, threaded bolts, screws, rivets, etc., or any other suitable securing means as is known in the art. Typically, when the magnetic components are bolted or screwed onto the mudflaps in a conventional manner, the magnetic component is intended to be attached to the vehicle mudflap and not removed, although it could be removed if the magnetic component and/or mudflap, as a whole were damaged or otherwise needed to be replaced. However, when the magnetic component is secured via a magnetic attachment to the vehicle mudflap, typically a receptor component is positioned behind the mudflap, and the magnetic component is placed in front of the mudflap, sandwiching the mudflap as a unitary structure. The receptor component would have the opposite polarity to the magnetic component to create the magnetic attraction needed to secure the magnetic component to the receptor component with the mudflap in between. The magnetic attraction must be sufficient to keep the magnetic component secured and in contact during normal usage but capable of disengagement when a user wishes to replace a damaged mudflap and/or magnetic component. Accordingly, this magnetic securing means allows the magnetic component to be easily removed and replaced, as needed. Thus, magnetic attachment can retain the magnetic component in position on the mudflap without the use of small parts that can be easily lost or misplaced and allows for rapid replacement of damaged magnetic components without the use of tools.

In one embodiment, the magnetic component can be applied to the mudflaps positioned at the front of the vehicle, in front of the front tires. In another embodiment, the magnetic component can be applied to the mudflaps positioned both at the front and rear of the vehicle, in front of the tires.

In one embodiment, once in position on the mudflaps, the magnetic component acts to attract metallic debris, such as ferrous materials from the roadway. A magnetic attraction is generated between the magnetic component and the ferrous material, which attracts the debris and retains it on the front surface of the magnetic component until manually removed. Thus, the magnetic component acts to pick up the metallic debris before it flattens and/or punctures tires.

In yet another embodiment, the flat tire prevention device comprises a plurality of indicia.

In yet another embodiment, a method of reducing the chance of getting a flat tire while driving is disclosed. The method includes the steps of providing a flat tire prevention device comprising a magnetic component configured in a square or rectangular shape. The method also comprises adhering the magnetic component to a vehicle's mudflaps. Further, the method comprises driving the vehicle. Finally, the method comprises attracting and picking up metallic debris before it punctures the vehicle's tires.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the flat tire prevention device of the present invention showing the device applied to a set of mudflaps in accordance with the disclosed architecture;

FIG. 2 illustrates a perspective view of one embodiment of the flat tire prevention device of the present invention showing how the device collects debris in accordance with the disclosed architecture;

FIG. 3 illustrates a perspective view of one embodiment of the flat tire prevention device of the present invention showing how the device is applied to a vehicle in accordance with the disclosed architecture;

FIG. 4 illustrates a perspective view of one embodiment of the flat tire prevention device of the present invention showing the device in use in accordance with the disclosed architecture; and

FIG. 5 illustrates a flowchart showing the method of reducing the chance of getting a flat tire while driving in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a flat tire prevention device that provides users with a means for preventing flat tires for cars, trucks, vans, SUVs, and any other vehicles. There is also a long-felt need in the art for a flat tire prevention device that features a magnetic interior that secures the device on the mudflap near the vehicle's front tires. Further, there is a long-felt need in the art for a flat tire prevention device that allows nails, screws, and other magnetic debris to be collected by the magnetic front plate on the device. Moreover, there is a long-felt need in the art for a device that reduces the chance of getting a flat tire, preventing unexpected expenses, or getting stranded in dangerous areas. Further, there is a long-felt need in the art for a flat tire prevention device that allows users to secure the device to a vehicle and its mudflap via a magnetic connection. Finally, there is a long-felt need in the art for a flat tire prevention device that comprises a magnetic interior to attract debris before it is run over by the tires.

The present invention, in one exemplary embodiment, is a novel flat tire prevention device. The flat tire prevention device comprises a magnetic component that is configured in a square or rectangular shape depending on the size and shape of the vehicle's mudflaps. The magnetic component is typically a thin, magnetic plate that would magnetically adhere to a vehicle's mudflaps, during use. The exposed surface of the magnetic component would also be magnetic, to attract debris before it is run over by the vehicle's tires. Thus, the magnetic component extends over the roadway area to pick up any metallic debris before it punctures the vehicle's tires. The present invention also includes a novel method of reducing the chance of getting a flat tire while driving. The method includes the steps of providing a flat tire prevention device comprising a magnetic component configured in a square or rectangular shape. The method also comprises adhering the magnetic component to a vehicle's mudflaps. Further, the method comprises driving the vehicle. Finally, the method comprises attracting and picking up metallic debris before it punctures the vehicle's tires.

Referring initially to the drawings, FIG. 1 illustrates a perspective view of one embodiment of the flat tire prevention device 100 of the present invention. In the present embodiment, the flat tire prevention device 100 is an improved flat tire prevention device 100 that provides a user with a metallic debris catching device that helps prevent flat or punctured tires 110 while driving. Specifically, the flat tire prevention device 100 comprises a magnetic component 102 that is secured to a vehicle mudflap 104, during use. The exposed surface (i.e., front surface 106) of the magnetic component 102 would be magnetic, to attract debris 108 before it is run over by the vehicle's tires 110. Thus, the magnetic component 102 extends over the roadway area to pick up any metallic debris 108 before it punctures and/or flattens the vehicle's tires 110.

Generally, the flat tire prevention device 100 reduces the chance of getting a flat tire, preventing unexpected expenses, or getting stranded in dangerous areas due to a flat and/or punctured tire. The flat tire prevention device 100 can be secured to any suitable vehicle 112, such as cars, trucks, vans, SUVs, RVs, etc., or any other suitable vehicle 112 as is known in the art. Generally, the flat tire prevention device 100 can be secured to any existing vehicle mudflap 104 as is known in the art or can be secured to a stand-alone mudflap 104 which is then secured to a vehicle 112.

Furthermore, the flat tire prevention device 100 comprises a magnetic component 102 that is configured in a square or rectangular shape depending on the size and shape of the vehicle's mudflaps 104 but can be configured in any suitable shape as is known in the art. Further, the magnetic component 102 is typically a thin, magnetic plate that partially covers the vehicle's mudflaps 104. Accordingly, the magnetic component 102 can be any suitable size and shape as is known in the art, as long as, the magnetic component 102 acts to cover a majority of a vehicle's mudflaps 104. Typically, the magnetic component 102 comprises a front surface 106 (facing away from the vehicle 112), a rear surface 114 (facing the mudflap 104 or tire 110), opposing side walls 116, and opposing top 118 and bottom 120 edges. The width of the magnetic component 102 can be approximately between ⅛-½″ thick, the thicker the width, the more heavy-duty the magnetic component 102. Any suitable width for the magnetic component 102 can be utilized as is known in the art.

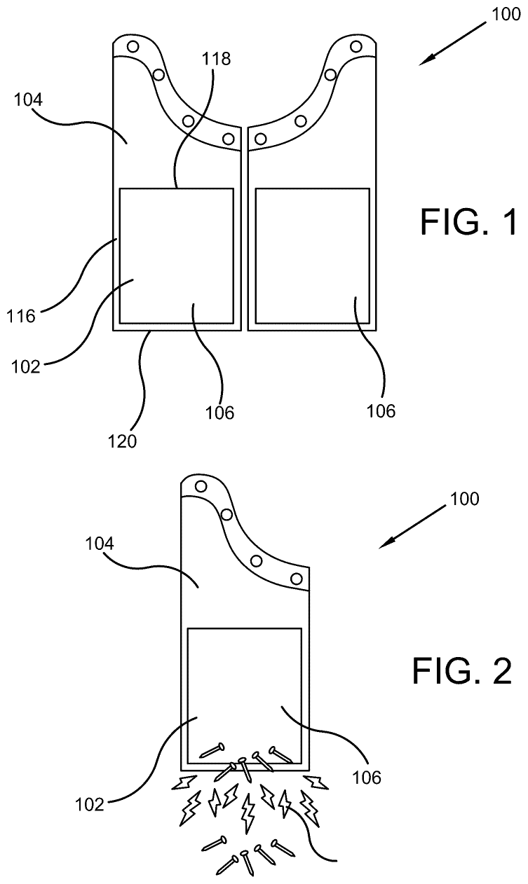

As shown in FIG. 2, the magnetic component 102 is manufactured of a permanent magnet. Permanent magnets do not lose their magnetic property once they are magnetized. Typical examples of permanent magnets include ceramic or ferrite, alnico (made from combining mostly aluminum, nickel, iron, and cobalt), samarium cobalt (SmCo), or neodymium iron boron (NIB). Samarium cobalt and neodymium iron boron are rare earth magnets. The magnetic component 102 can be manufactured with any of these magnets, including the rare earth magnets, or any other suitable magnet as is known in the art.

Further, while the magnetic component 102 is shown as being mounted to a vehicle's mudflaps 104 aftermarket, such that the magnetic component 102 and the mudflap 104 are separate components, it would be obvious to one of skill in the art that the magnetic component 102 and the mudflap 104 can be a unitary construction, formed together beforehand and then secured to a vehicle 112 as a single component. Thus, the magnetic component 102 can either be secured directly to the vehicle's mudflap 104 which is already positioned on a vehicle 112, or the magnetic component 102 can be secured to a stand-alone mudflap 104 which is then secured to a vehicle 112, after the magnetic component 102 has been applied to it.

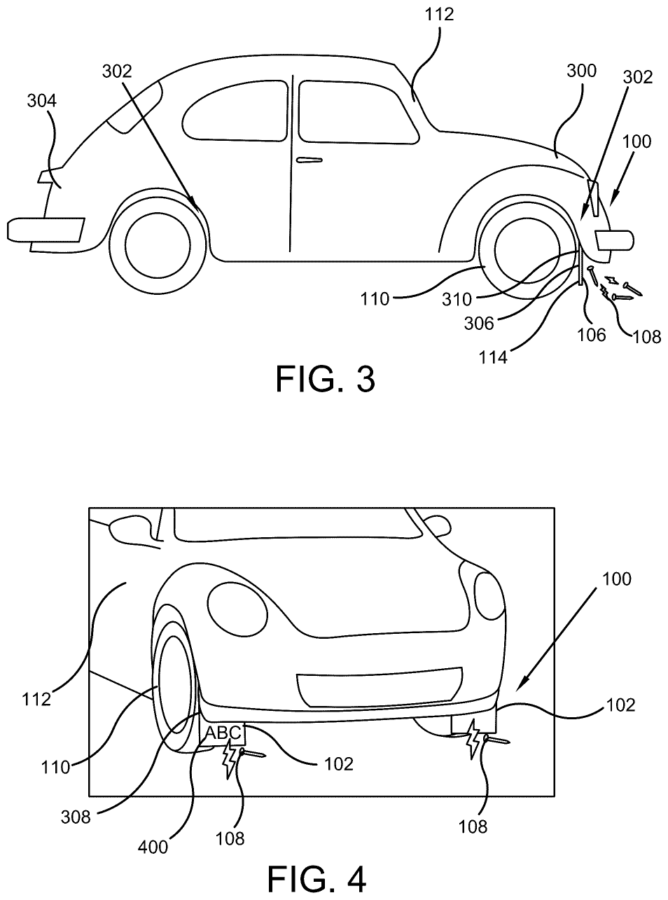

As shown in FIG. 3, the magnetic component 102 can be applied to the mudflaps 104 positioned at the front 300 of the vehicle 112, and in front 302 of the front tires 110. In another embodiment, the magnetic component 102 can be applied to the mudflaps 104 positioned both at the front 300 and rear 304 of the vehicle 112, in front 302 of the tires 110. However, the magnetic component 102 can be applied to mudflaps 104 in any suitable position as is known in the art on the vehicle 112, depending on the needs and/or wants of a user.

Furthermore, the magnetic component 102 is secured to a vehicle's mudflaps 104 via a magnetic attachment 306, threaded bolts 308, screws, rivets, etc., or any other suitable securing means as is known in the art. Typically, when the magnetic components 102 are bolted or screwed onto the mudflaps 104 in a conventional manner, the magnetic component 102 is intended to be attached to the vehicle mudflap 104 and not removed, although it could be removed if the magnetic component 102 and/or mudflap 104, as a whole were damaged or otherwise needed to be replaced.

However, when the magnetic component 102 is secured via a magnetic attachment 306 to the vehicle mudflap 104, typically a receptor component 310 is positioned behind the mudflap 104, and the magnetic component 102 is placed in front of the mudflap 104, sandwiching the mudflap 104 as a unitary structure. The receptor component 310 would have the opposite polarity to the magnetic component 102 to create the magnetic attraction needed to secure the magnetic component 102 to the receptor component 310 with the mudflap 104 in between. The magnetic attraction 306 must be sufficient to keep the magnetic component 102 secured and in contact during normal usage but capable of disengagement when a user wishes to replace a damaged mudflap 104 and/or magnetic component 102. Accordingly, this magnetic securing means allows the magnetic component 102 to be easily removed and replaced, as needed. Thus, magnetic attachment 306 can retain the magnetic component 102 in position on the mudflap 104 without the use of small parts that can be easily lost or misplaced and allows for rapid replacement of damaged magnetic components 102 without the use of tools.

As shown in FIG. 4, the flat tire prevention device 100 comprises a plurality of indicia 400. The magnetic component 102 of the device 100 may include advertising, a trademark, or other letters, designs, or characters, printed, painted, stamped, or integrated into the magnetic component 102, or any other indicia 400 as is known in the art. Specifically, any suitable indicia 400 as is known in the art can be included, such as, but not limited to, patterns, logos, emblems, images, symbols, designs, letters, words, characters, animals, advertisements, brands, etc., that may or may not be mudflap, magnetic, or brand related.

Furthermore, once in position on the mudflaps 104, the magnetic component 102 acts to attract metallic debris 108, such as ferrous materials from the roadway. A magnetic attraction is generated between the magnetic component 102 and the ferrous material 108, which attracts the debris 108 and retains it on the front surface 106 of the magnetic component 102 until manually removed. Thus, the magnetic component 102 acts to pick up the metallic debris 108 before it flattens and/or punctures tires 110.

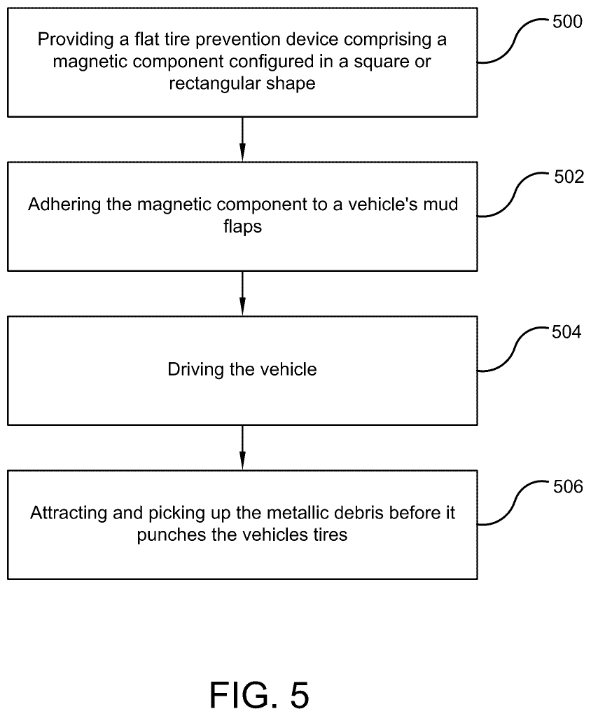

FIG. 5 illustrates a flowchart of the method of reducing the chance of getting a flat tire while driving. The method includes the steps of at 500, providing a flat tire prevention device comprising a magnetic component configured in a square or rectangular shape. The method also comprises at 502, adhering the magnetic component to a vehicle's mudflaps. Further, the method comprises at 504, driving the vehicle. Finally, the method comprises at 506, attracting and picking up metallic debris before it punctures the vehicle's tires.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “flat tire prevention device”, “flat tire device”, “prevention device”, and “device” are interchangeable and refer to the flat child prevention device 100 of the present invention.

Notwithstanding the foregoing, the flat tire prevention device 100 of the present invention can be of any suitable size and configuration as is known in the art without affecting the overall concept of the invention, provided that it accomplishes the above-stated objectives. One of ordinary skill in the art will appreciate that the flat tire prevention device 100 as shown in FIGS. 1-5 is for illustrative purposes only, and that many other sizes and shapes of the flat tire prevention device 100 are well within the scope of the present disclosure. Although the dimensions of the flat tire prevention device 100 are important design parameters for user convenience, the flat tire prevention device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flat tire prevention device that provides a user with a means for preventing flat or punctured tires, the flat tire prevention device comprising:
a magnetic component;
wherein the magnetic component is secured to a vehicle's mudflap; and
further wherein the magnetic component attracts and picks up any metallic debris before it punctures and flattens a vehicle's tires.

2. The flat tire prevention device of claim 1, wherein the magnetic component is configured in a square or rectangular shape.

3. The flat tire prevention device of claim 2, wherein the magnetic component is a thin, magnetic plate that partially covers the vehicle's mudflaps.

4. The flat tire prevention device of claim 3, wherein the magnetic component comprises a front surface, a rear surface, opposing side walls, and opposing top and bottom edges.

5. The flat tire prevention device of claim 4, wherein a width of the magnetic component is approximately between ⅛-½″ thick.

6. The flat tire prevention device of claim 5, wherein the magnetic component is manufactured of a permanent magnet, such as ceramic or ferrite, alnico, samarium cobalt (SmCo), or neodymium iron boron (NIB).

7. The flat tire prevention device of claim 6, wherein the magnetic component is mounted to an existing vehicle mudflap, which is already attached to a vehicle.

8. The flat tire prevention device of claim 6, wherein the magnetic component is secured to a stand-alone mudflap which is then secured to a vehicle, after the magnetic component has been applied to it.

9. The flat tire prevention device of claim 6, wherein the magnetic component is applied to mudflaps positioned at a front of a vehicle, in front of a vehicle's front tires.

10. The flat tire prevention device of claim 6, wherein the magnetic component is applied to mudflaps positioned both at a front and a rear of a vehicle, in front of a vehicle's tires.

11. The flat tire prevention device of claim 6, wherein the magnetic component is secured to a vehicle's mudflaps via a magnetic attachment.

12. The flat tire prevention device of claim 6, wherein the magnetic component is secured to a vehicle's mudflaps via threaded bolts.

13. A flat tire prevention device that provides a user with a means for preventing flat or punctured tires, the flat tire prevention device comprising:
a magnetic component configured in a square or rectangular shape;
wherein the magnetic component is a thin, magnetic plate that partially covers the vehicle's mudflaps;
wherein the magnetic component is secured to a vehicle's mudflap via a magnetic attachment;
wherein a receptor component is positioned behind the vehicle's mudflap and the magnetic component is placed in front of the vehicle's mudflap, sandwiching the vehicle's mudflap as a unitary structure; and
wherein the magnetic component attracts and picks up any metallic debris before it punctures and flattens a vehicle's tires.

14. The flat tire prevention device of claim 13, wherein the receptor component has opposite polarity to the magnetic component to create the magnetic attraction needed to secure the magnetic component to the receptor component with the vehicle's mudflap in between.

15. The flat tire prevention device of claim 13, wherein the magnetic component is manufactured of a permanent magnet, such as ceramic or ferrite, alnico, samarium cobalt (SmCo), or neodymium iron boron (NIB).

16. The flat tire prevention device of claim 13, wherein the magnetic component is applied to mudflaps positioned at a front of a vehicle, in front of a vehicle's front tires.

17. The flat tire prevention device of claim 13 further comprising a plurality of indicia.

18. The flat tire prevention device of claim 13, wherein the metallic debris are ferrous materials from a roadway.

19. The flat tire prevention device of claim 18, wherein a magnetic attraction is generated between the magnetic component and the ferrous materials, which causes the ferrous materials to be attracted and retained on a front surface of the magnetic component until manually removed.

20. A method of reducing the chance of getting a flat tire while driving, the method comprising the following steps:
providing a flat tire prevention device comprising a magnetic component configured in a square or rectangular shape;
adhering the magnetic component to a vehicle's mudflaps;
driving the vehicle; and
attracting and picking up metallic debris before it punctures the vehicle's tires.
